(19) United States
(12) Patent Application Publication
(10) Pub. No.: US 2022/0069496 A1
(43) Pub. Date: Mar. 3, 2022

(54) MINIATURIZED ELECTRICAL CONNECTOR FOR COMPACT ELECTRONIC SYSTEM

(71) Applicant: Amphenol Commercial Products (Chengdu) Co., Ltd., Chengdu (CN)

(72) Inventors: Luyun Yi, Chengdu (CN); Jing Wang, Chengdu (CN)

(73) Assignee: Amphenol Commercial Products (Chengdu) Co., Ltd., Chengdu (CN)

(21) Appl. No.: 17/402,255

(22) Filed: Aug. 13, 2021

(30) Foreign Application Priority Data
Aug. 31, 2020 (CN) 202021855660.5

(51) Int. Cl. H01R 12/72

(52) U.S. Cl. CPC H01R 12/724; H01R 12/737; H01R 12/727

(57) ABSTRACT

The present disclosure provides an electrical connector. The electrical connector comprises an insulative housing and a plurality of terminals disposed in the insulative housing. The insulative housing comprises a top face, a bottom face opposite to the top face, and a plurality of side faces extending between the top face and the bottom face. A corner portion between at least two adjacent side faces of the side faces is formed as a chamfered surface. Such a configuration reduces the dimension of the electrical connector, enables a more compact arrangement of components on the electronic system, and enables the dimension of the electronic system to be reduced, such that the entire assembly, including the electrical connector and the electronic system, can be manufactured at a lower cost and can be more compact and more lightweight.

### RELATED APPLICATIONS

This application claims priority to and the benefit of Chinese Patent Application Serial No. 202021855660.5, filed on Aug. 31, 2020. The entire contents of this application are incorporated herein by reference in their entirety.

### FIELD

This application relates to electrical connectors, and in particular to an electrical connector for providing an electrical connection between electronic systems, such as printed circuit boards (PCBs).

### BACKGROUND

Electrical connectors may be used to electrically connect different electronic systems together. One typical electrical connector is a card edge connector that may be mounted onto a first electronic system, such as a motherboard, such that tail portions of terminals of the card edge connector may be electrically connected to conductive portions of the first electronic system by, for example, soldering. The card edge connector may also act as a female connector for interfacing directly with conductive portions on or near an edge of a PCB of a second electronic system, such as a daughter card, such that the conductive portions of the second electronic system are in contact with the contact portions of the corresponding terminals of the card edge connector. In this case, the PCB itself acts as a male connector for interfacing with the card edge connector, without the need for a separate male connector. In this way, the conductive portions of the second electronic system may be electrically connected to the corresponding conductive portions of the first electronic system via the terminals of the card edge connector, thereby establishing an electrical connection between the first electronic system and the second electronic system. This makes it possible to manufacture individual PCBs for a specific purpose and then electrically connect the individual PCBs together using the card edge connector(s) to form a desired system, rather than manufacturing the entire system as a single component.

### BRIEF SUMMARY

Aspects of the present disclosure relate to miniaturized electrical connectors for compact electronic systems.

Some embodiments relate to an electrical connector. The electrical connector may include an insulative housing, and a plurality of terminals disposed in the insulative housing. The insulative housing may include a top face comprising a socket, a bottom face opposite to the top face, and a plurality of side faces extending between the top face and the bottom face, the plurality of side faces comprising first and second side faces extending perpendicularly to each other. Each of the plurality of terminals may include a contact portion and a tail portion, the contact portion being accessible through the socket of the insulative housing, and the tail portion protruding from the bottom face of the insulative housing. The insulative housing comprises a chamfered surface connecting one of the first side faces and one of the second side faces.

In some embodiments, the insulative housing may include a platform projecting outwardly at one end of the insulative housing that is proximate to the bottom face.

In some embodiments, the platform may include a corner portion comprising the chamfered surface.

In some embodiments, the chamfered surface may be a first chamfered surface. The platform may include a second chamfered surface such that the platform has a trapezoidal shape.

In some embodiments, the plurality of terminals may be arranged in two terminal rows mutually opposed and spaced apart in the insulative housing, with the terminals in each terminal row aligned therein.

In some embodiments, the electrical connector may include at least one retention mechanism for retaining the plurality of terminals in place relative to each other.

In some embodiments, the at least one retention mechanism may be overmolded around the plurality of terminals.

In some embodiments, the insulative housing may include the at least one retention mechanism.

In some embodiments, the at least one retention mechanism may be formed separately from the insulative housing and removably mounted into the insulative housing.

In some embodiments, the retention mechanism may include two halves having interlocking mechanisms. Each half may retain a terminal row formed by some of the plurality of terminals.

In some embodiments, the electrical connector may include a positioning mechanism for ensuring a proper positioning of the electrical connector on the electronic system when the electrical connector is mounted to an electronic system.

In some embodiments, the electrical connector may include a fixing mechanism for fixing the electrical connector to an electronic system.

In some embodiments, the electrical connector may be a vertical connector or a right angle connector.

In some embodiments, the electronic system may be a printed circuit board.

In some embodiments, the one of the first side faces may extend in a first plane. The one of the second side faces may extend in a second plane. The first plane and the second plane may cross each other along a line. The chamfered surface may be spaced from the line by a distance no less than 0.36 mm.

In some embodiments, the platform may include slots for receiving tabs.

Some embodiments relate to an electronic system. The electronic system may include a printed circuit board; and an electrical connector. The electrical connector may include an insulative housing and a plurality of terminals disposed in the insulative housing. The insulative housing may include a socket, a bottom face mounted against the printed circuit board, and a plurality of side faces extending perpendicular to the bottom face, the plurality of side faces comprising first and second side faces extending perpendicularly to each other. Each of the plurality of terminals may include a contact portion and a tail portion, the contact portion being accessible through the socket of the insulative housing, and the tail portion protruding from the bottom face of the insulative housing. The printed circuit board may include a first edge and a second edge and curved corner joining the first edge and the second edge. The electrical connector may be mounted to the printed circuit board with the first side face adjacent and parallel to the first edge and the second side face adjacent and parallel to the second edge. The insulative housing may include an angled surface connecting the first side face and the second side face. The angled surface may be mounted adjacent the curved corner.

In some embodiments, the insulative housing may include a socket portion including the socket and at least one platform extending from the socket portion in a direction parallel to the bottom face. The angled surface may include a surface of a platform of the at least one platform.

In some embodiments, the platform may be a first platform. The at least one platform may include a second platform, extending from the socket portion in a direction opposite the first platform. The angled surface may be a first angled surface. The second platform may include a second angled surface.

In some embodiments, the electronic system may include a plurality of fixing tabs extending through the first platform and the second platform and engaging the electrical connector to the printed circuit board

Some embodiments relate to an electrical connector. The electrical may include an insulative housing comprising a top face, a bottom face opposite to the top face and a plurality of side faces extending between the top face and the bottom face; and a plurality of terminals disposed in the insulative housing, each of the plurality of terminals comprising a contact portion and a tail portion, the contact portion being accessible through a socket in the insulative housing, and the tail portion protruding from the bottom face and configured to be mounted to an electronic system. A corner portion between at least two adjacent side faces of the side faces is formed as a chamfered surface.

In some embodiments, a portion of at least one end of the insulative housing that is proximate to the bottom face may project outwardly to form a platform.

In some embodiments, the chamfered surface may be formed at a corner portion of the platform.

In some embodiments, each of two corner portions of the platform may be formed as the chamfered surface such that the platform has a trapezoidal shape.

In some embodiments, the plurality of terminals may be arranged in two terminal rows mutually opposed and spaced apart in the insulative housing, with the terminals in each terminal row aligned therein.

In some embodiments, the electrical connector may include at least one retention mechanism for retaining the plurality of terminals in place relative to each other.

In some embodiments, the at least one retention mechanism may be overmolded around the plurality of terminals.

In some embodiments, the at least one retention mechanism may be provided by the insulative housing.

In some embodiments, the at least one retention mechanism may be formed separately from the insulative housing and removably mounted into the insulative housing.

In some embodiments, the retention mechanism may include two halves having interlocking mechanisms, each half retaining a terminal row formed by some of the plurality of terminals.

In some embodiments, the electrical connector may include a positioning mechanism provided on the insulative housing for ensuring a proper positioning of the electrical connector on the electronic system when the electrical connector is mounted to the electronic system.

In some embodiments, the electrical connector may include a fixing mechanism provided on the insulative housing for fixing the electrical connector to the electronic system.

In some embodiments, the electrical connector may be a vertical connector or a right angle connector.

In some embodiments, the electronic system may be a printed circuit board.

In some embodiments, the corner portion being formed as the chamfered surface may allow the corner portion to be indented inward by at least 0.36 mm, as compared to the case where the corner portion is not formed as the chamfered surface.

These techniques may be used alone or in any suitable combination. The foregoing summary is provided by way of illustration and is not intended to be limiting.

### BRIEF DESCRIPTION OF DRAWINGS

The above and other aspects of the present disclosure will be more thoroughly understood and appreciated below when read in conjunction with the appended drawings. It should be noted that the appended drawings are only schematic and are not drawn to scale. In the appended drawings:

FIG. 1 is a top, side perspective view of a vertical connector, according to some embodiments.

FIG. 2 is a bottom, side perspective view of the vertical connector shown in FIG. 1.

FIG. 3 is an exploded view of the vertical connector shown in FIG. 1.

FIG. 4 is a front plan view of the vertical connector shown in FIG. 1.

FIG. 5A is a top plan view of the vertical connector shown in FIG. 1.

FIG. 5B is an enlarged view of the area A circled by the dashed line in FIG. 5A.

FIG. 5C is a top plan view of a printed circuit board mounted with a vertical connector that have conventional corner portions.

FIG. 5D is a top plan view of a printed circuit board mounted with the vertical connector of FIG. 1, which has chamfered corner portions.

FIG. 6 is a bottom plan view of the vertical connector shown in FIG. 1.

FIG. 7A is a front plan view of a set of three terminals that may be used in the vertical connector shown in FIG. 1.

FIG. 7B is a right side plan view of the set of three terminals shown in FIG. 7A.

FIG. 7C is a bottom plan view of the set of three terminals shown in FIG. 7A.

FIG. 7D is a perspective view of the set of three terminals shown in FIG. 7A.

FIG. 8A is a front plan view of a terminal row comprising nine sets of the three terminals shown in FIG. 7A and an additional ground terminal.

FIG. 8B is a bottom plan view of the terminal row shown in FIG. 8A.

FIG. 8C is a perspective view of the terminal row shown in FIG. 8A.

### LIST OF REFERENCE NUMERALS

100 vertical connector

101 housing

103 top face

105 bottom face

107 front side face

109 rear side face

111 left side face

113 right side face

115 first retention mechanism

117 second retention mechanism

119 first socket

121 second socket

123 positioning protrusion

125 fixing tab

127 receiving slot

129 first platform

131 second platform

133 chamfered surface

200 terminals

201 tip portion

203 contact portion

205 body portion

207 tail portion

210 ground terminal

220 first signal terminal

230 second signal terminal

240 additional ground terminal

300 terminal row

400 printed circuit board

401 edge.

### DETAILED DESCRIPTION

Disclosed herein is a miniaturized electrical connector. The electrical connector may include an insulative housing and a plurality of terminals disposed in the insulative housing. The insulative housing may include a top face, a bottom face opposite to the top face, and a plurality of side faces extending between the top face and the bottom face. Each of the plurality of terminals may include a contact portion and a tail portion. The contact portion may be accessible through a socket in the insulative housing, and the tail portion may protrude from the bottom face and may be capable of being mounted to an electronic system. A corner portion between at least two adjacent side faces of the side faces may be formed as a chamfered surface.

Such configuration may reduce the dimension of the electrical connector. For example, when the electrical connector is mounted to an electronic system such as a PCB, the electrical connector may occupy less space and be disposed closer to other components on the electronic system, enabling a more compact arrangement of the components on the electronic system. Alternatively or additionally, the electrical connector may be disposed closer to an edge of the electronic system, such that the space utilization on the electronic system can be optimized. These also enable the dimension of the electronic system to be reduced, such that the entire assembly, including the electrical connector and the electronic system, can be manufactured at a lower cost and can be more compact and more lightweight.

The electrical connectors of the present disclosure may be various types of card edge connectors, including but not limited to, vertical connectors and right angle connectors. Preferred embodiments of the present disclosure are described in detail below in conjunction with some examples. It should be appreciated by the skilled person in the art that these embodiments are not meant to form any limitation on the present disclosure.

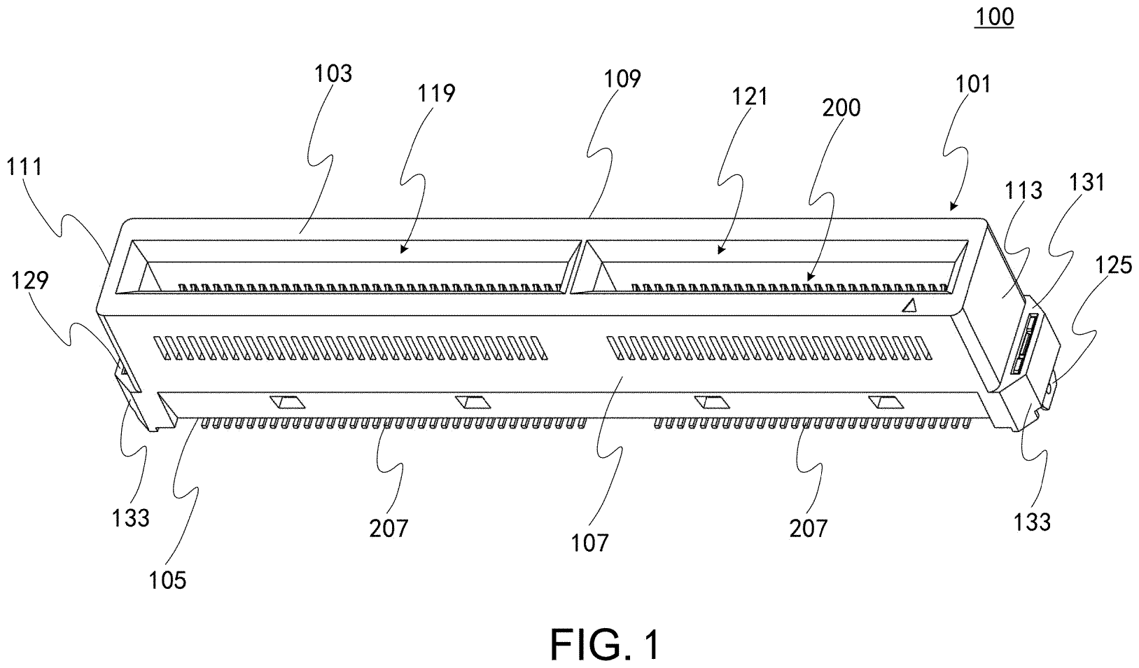

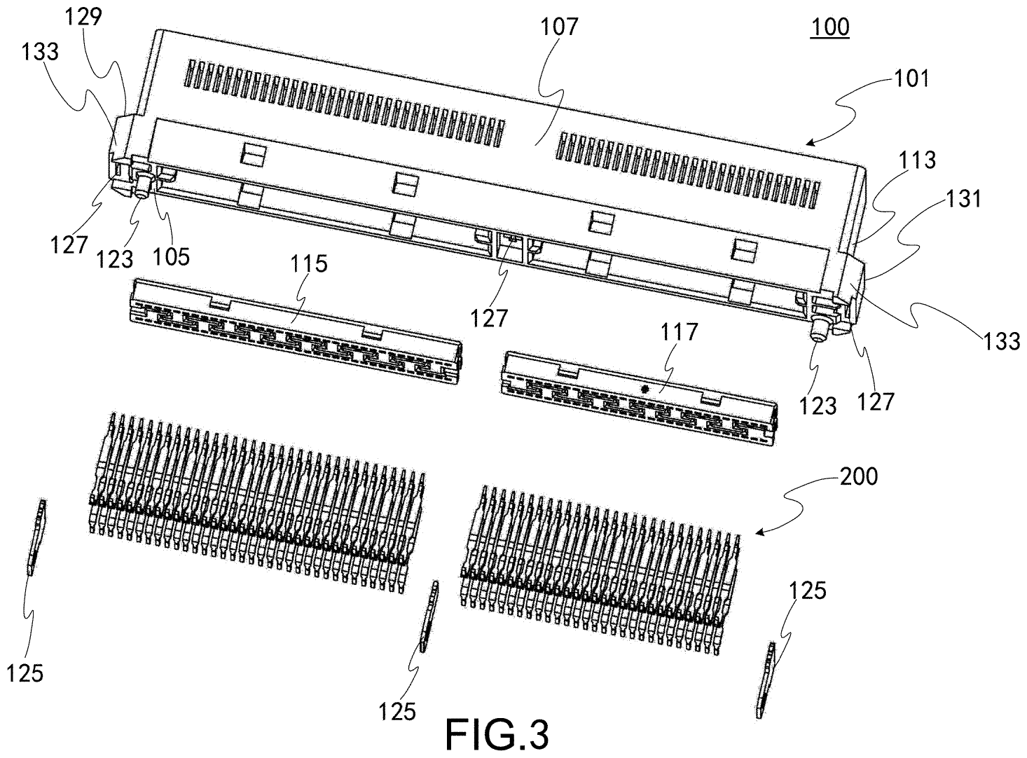

The vertical connector 100 according to a preferred embodiment of the present disclosure will be described below in conjunction with FIGS. 1 to 8C. As shown in FIGS. 1 to 6, the vertical connector 100 may include a housing 101. The housing 101 may be partially or entirely formed of an insulative material. Examples of insulative materials that are suitable for forming the housing 101 include, but are not limited to, plastic, nylon, liquid crystal polymer (LCP), polyphenyline sulfide (PPS), high temperature nylon or polyphenylenoxide (PPO) or polypropylene (PP). The housing 101 may have a substantially bar shaped body and may include a top face 103, a bottom face 105 opposite to the top face 103 and a plurality of side faces extending between the top face 103 and the bottom face 105. In some examples, the housing 101 may include four side faces, i.e., wider front and rear side faces 107 and 109 and narrower left and right side faces 111 and 113.

The vertical connector 100 may further include a plurality of terminals 200 housed in the housing 101. Each of the plurality of terminals 200 may be formed of a conductive material. Conductive materials that are suitable for forming the terminals 200 may be a metal, such as copper, or a metal alloy. A set of three terminals 200 may be configured for transmitting differential signals between a first electronic device (e.g., a motherboard) and a second electronic device (e.g., a daughter board).

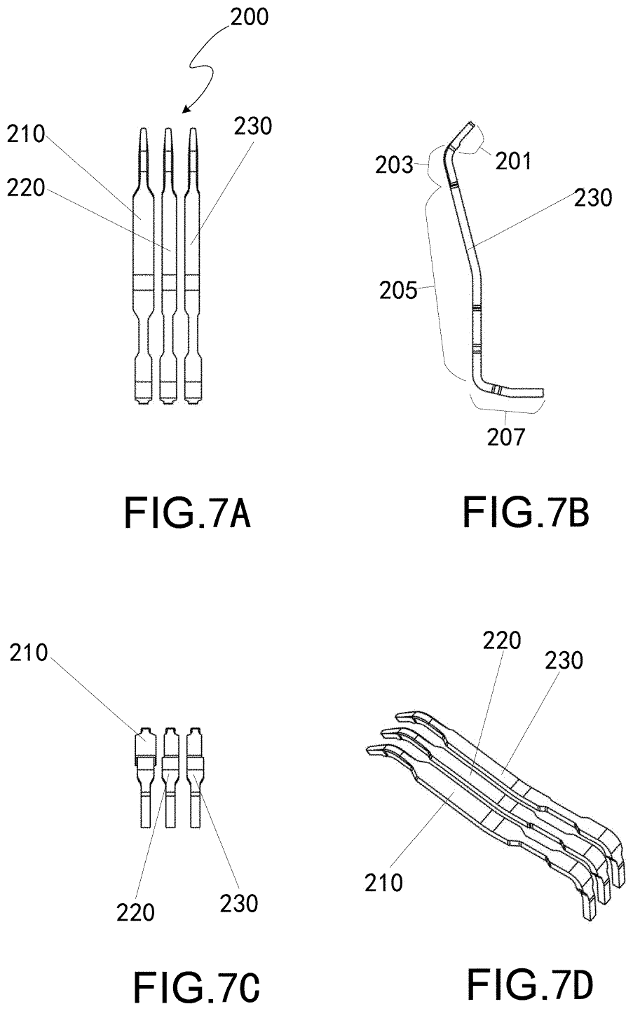

Turning to FIGS. 7A to 7D, FIGS. 7A to 7D illustrate in detail a set of three terminals 200 that may be used in the vertical connector 100, i.e., a ground terminal 210, a first signal terminal 220 and a second signal terminal 230. FIG. 7A is a front view of the set of three terminals 200. FIG. 7B is a right side view of the set of three terminals 200 shown in FIG. 7A, but only the second signal terminal 230 is visible because all of the three terminals have the same profiles when viewed from the right side thereof. FIG. 7C is a bottom view of the set of three terminals 200 shown in FIG. 7A. FIG. 7D is a perspective view of the set of three terminals 200 shown in FIG. 7A.

The first signal terminal 220 and the second signal terminal 230 may constitute a differential signaling pair. Each of the ground terminal 210, the first signal terminal 220 and the second signal terminal 230 includes a tip portion 201, a contact portion 203, a body portion 205 and a tail portion 207. The tail portion 207 may be configured for being connected to a first PCB (e.g., a motherboard). The contact portion 203 may be configured to establish an electrical contact with a conductive portion of another electronic system (e.g., another PCB).

In some examples, the distance D1 between the distal ends of the tip portion 201 of the first signal terminal 220 and the tip portion 201 of the second signal terminal 230 is equal to the distance D2 between the distal ends of the tip portion 201 of the first signal terminal 220 and the tip portion 201 of the ground terminal 210. In some examples, the distance D3 between the contact portion 203 of the first signal terminal 220 and the contact portion 203 of the second signal terminal 230 is equal to the distance D4 between the contact portion 203 of the first signal terminal 220 and the contact portion 203 of the ground terminal 210. In some examples, the distances D3 and D4 are less than the distances D1 and D2, respectively. As a non-limiting example, D1 and D2 may be equal to 0.6 mm, and D3 and D4 may be equal to 0.38 mm. The vertical connector 100 has a terminal pitch equal to D1. Thus, in the example where D1 is equal to 0.6 mm, the vertical connector 100 may be referred to as a 0.6 mm card edge connector.

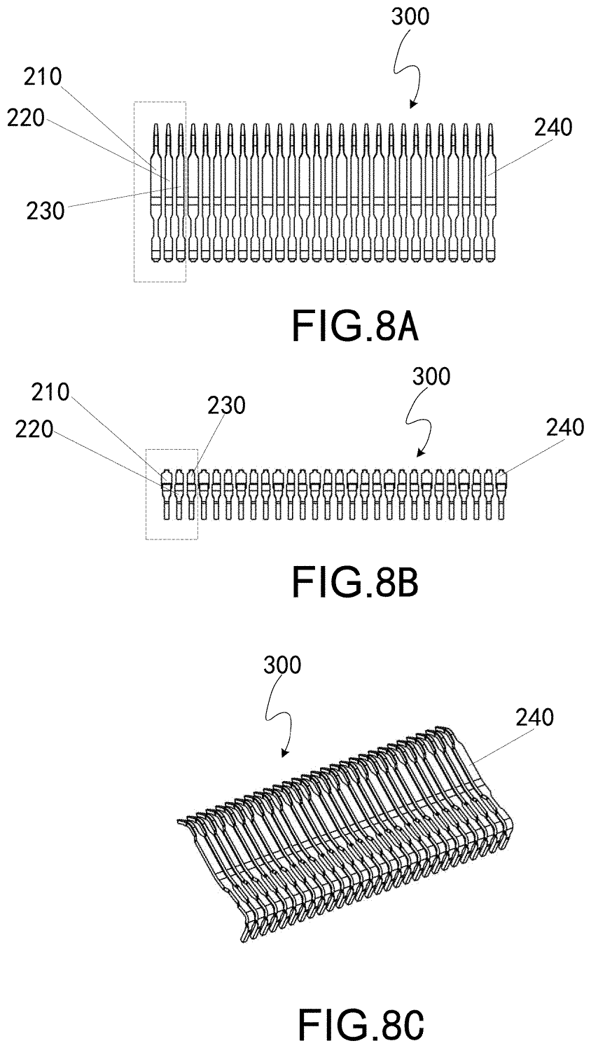

A plurality of sets of three terminals 200 may be arranged in terminal rows, with the terminals in each terminal row aligned therein. FIG. 8A is a front view of a terminal row 300 formed by nine sets of three terminals and an additional ground terminal 240, according to some embodiments. FIG. 8B is a bottom view of the terminal row 300 shown in FIG. 8A. FIG. 8C is a perspective view of the terminal row 300 shown in FIG. 8A. A set of three terminals 200 is arranged such that the tip portion of each terminal in the terminal row 300 is the same distance from the tip portion of each adjacent terminal. For example, if the pitch of the tip portions of the terminals in a set of three terminals 200 is 0.6 mm, then the pitch between the tip portions of the terminals from an immediately adjacent set of three terminals 200 is also 0.6 mm. It should be appreciated that the plurality of terminals 200 may be in other suitable forms.

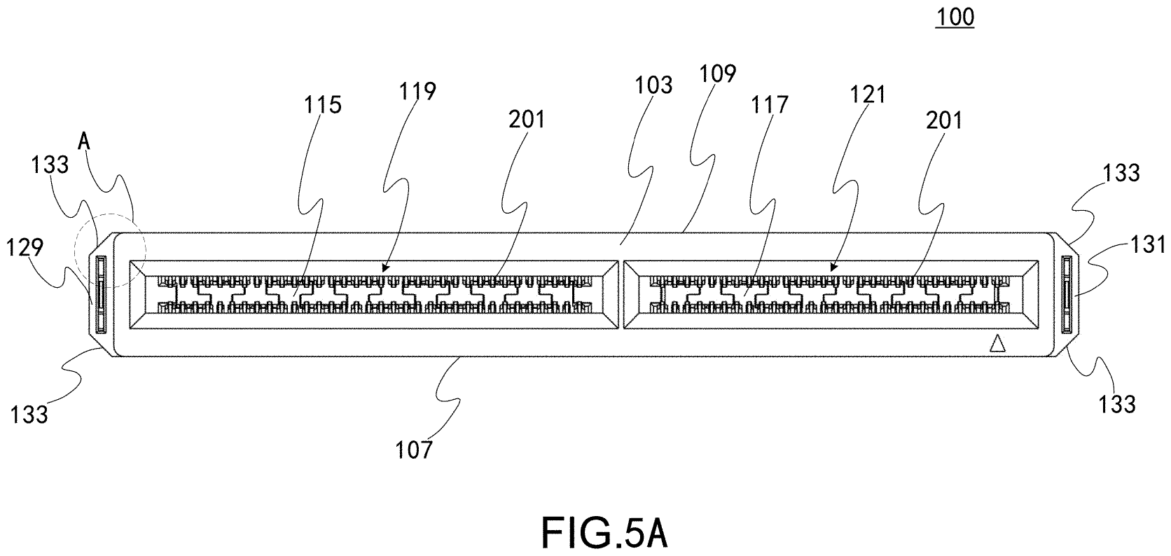

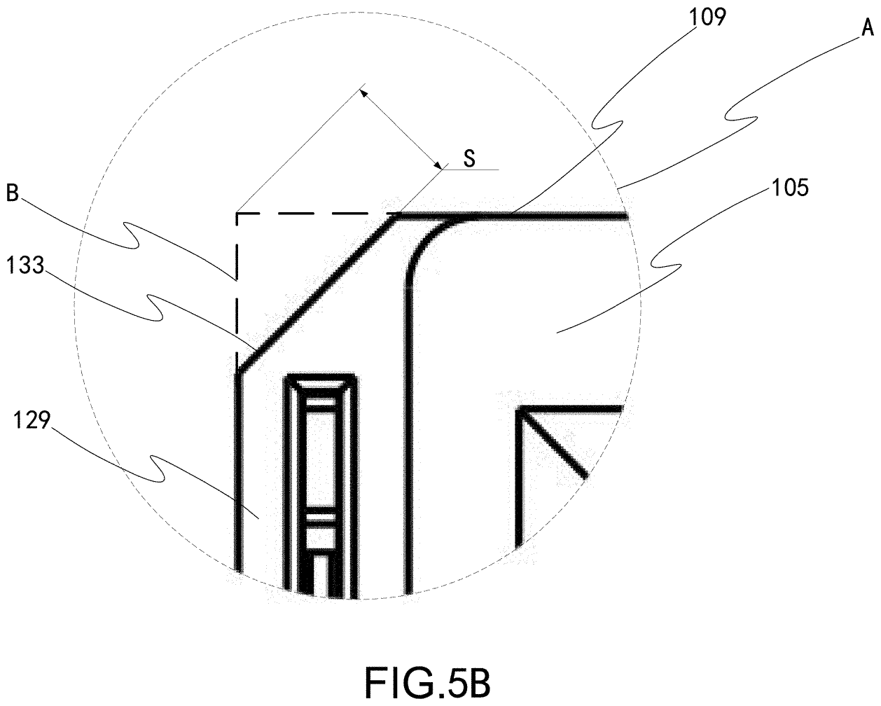

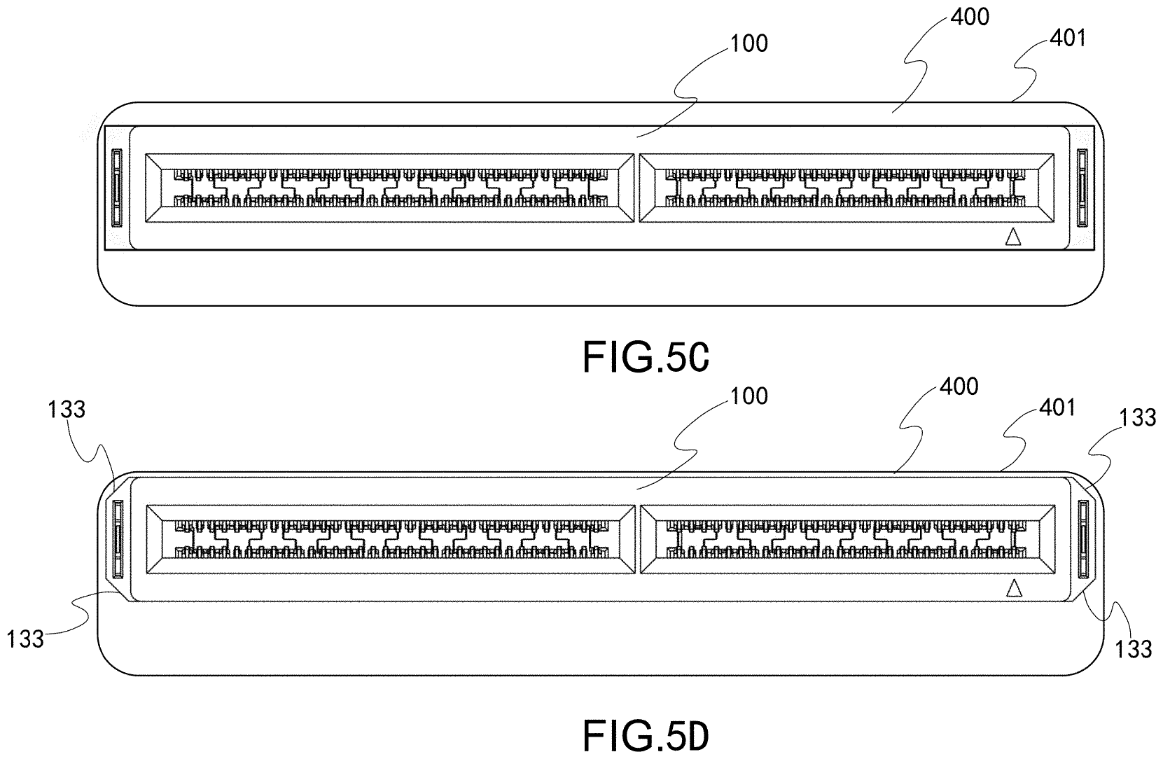

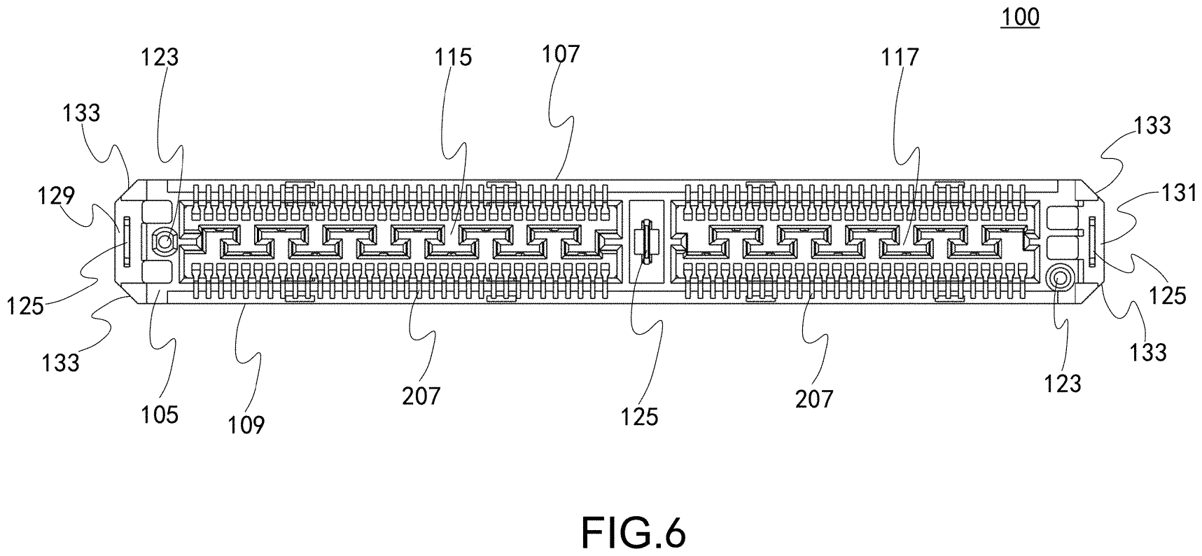

As shown in FIGS. 5A and 6, when the terminals 200 are received in the housing 101, the terminals 200 are arranged in two terminal rows mutually opposed and spaced apart, with the terminals in each terminal row aligned therein. The two terminal rows may be spaced apart in a manner that the terminals 200 are offset from each other or aligned with each other. Conductive portions of the second PCB (e.g., a daughter board) may be inserted between the two terminal rows, such that the conductive portions of the second PCB are disposed in contact with the contact portions 203 of the corresponding terminals 200.

In some embodiments, the vertical connector 100 may include at least one retention mechanism for retaining the plurality of terminals 200 in place relative to each other. The retention mechanism may be partially or entirely formed of an insulative material. Examples of insulative materials that are suitable for forming the retention mechanism include, but are not limited to, plastic, nylon, liquid crystal polymer (LCP), polyphenyline sulfide (PPS), high temperature nylon or polyphenylenoxide (PPO) or polypropylene (PP).

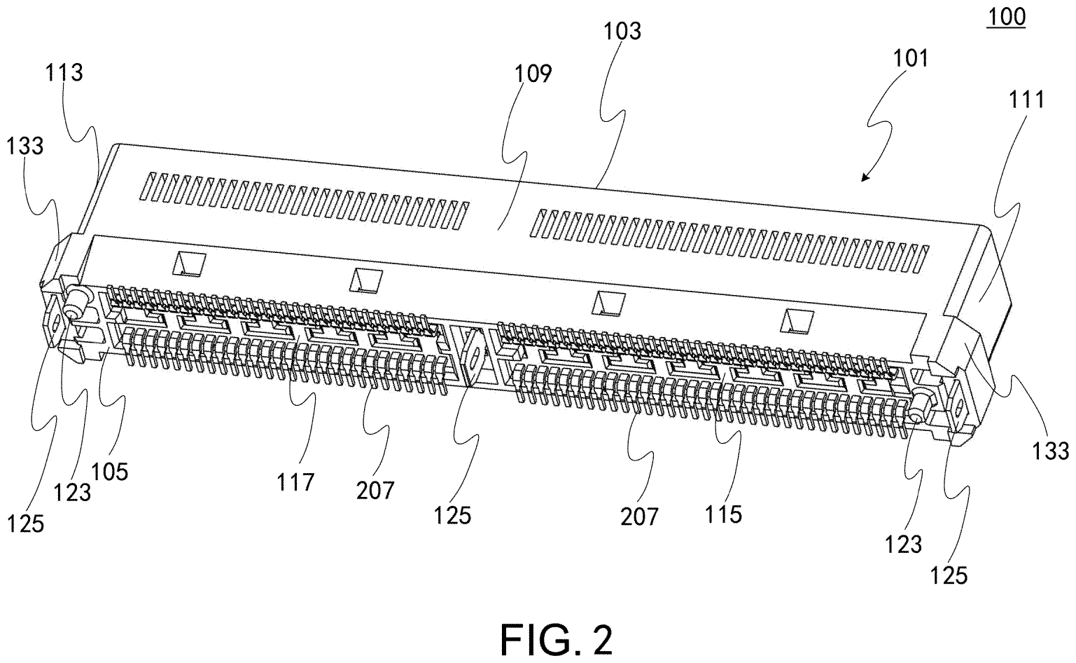

At least one retention mechanism may be overmolded around the plurality of terminals 200. In some examples, the at least one retention mechanism may be formed separately from the housing 101 and then removably mounted into the housing 101. Turning back to FIGS. 2, 3, 5A and 6, two retention mechanisms, i.e., a first retention mechanism 115 and a second retention mechanism 117, are shown in the figures. In some examples, each of the first retention mechanism 115 and the second retention mechanism 117 may be overmolded around a certain number of terminals 200 so as to retain the terminals in two terminal rows mutually opposed and spaced apart.

Then, the first retention mechanism 115 and the second retention mechanism 117 may be fitted into the housing 101, thereby retaining the terminal rows in the housing 101. In some examples, the first retention mechanism 115 and the second retention mechanism 117 may be provided with snap fit mechanisms for cooperating with corresponding mechanisms of the housing 101 so as to secure the retention mechanisms in the housing 101. In some examples, as shown in FIGS. 2, 3, 5A and 6, at least one of the first retention mechanism 115 and the second retention mechanism 117 may be a two-piece retention mechanism, which may include two halves having interlocking mechanisms, with each half retaining a terminal row formed by some of the plurality of terminals 200. Each half retains a terminal row and the two halves are locked in place relative to each other by the interlocking mechanisms. It should be appreciated that the vertical connector 100 may have other numbers and/or other forms of retention mechanisms. It should also be appreciated that the retention mechanism is not mandatory, but just optional. In some embodiments, the housing 101 may be overmolded directly around the terminal 200, without the need for a separate retention mechanism. That is, the housing 101 itself forms a retention mechanism.

As shown in FIGS. 2, 3, 5A and 6, when the terminals 200 are retained in the housing 101, the tail portions 207 of the terminals 200 may be arranged to protrude from the bottom face 105 of the housing 101 for connecting to the corresponding conductive portions of the first PCB (e.g., a motherboard). For example, each of the tail portions 207 may be bent in opposite directions relative to the body portion 205 so as to be connected to the first PCB. The connections may be achieved by soldering or other suitable means.

The top face 103 of the housing 101 of the vertical connector 100 may include at least one socket for allowing the contact portion 203 of each of the plurality of terminals 200 to be accessible therethrough. For example, the second PCB (e.g., a daughter board) may be inserted into the at least one socket, such that conductive portions (e.g., conductive traces) of the second PCB are arranged in contact with the contact portions 203 of the corresponding terminals 200. For example, the conductive portions of the second PCB may be received between two terminal rows mutually opposed and in contact with the contact portions 203 of the corresponding terminals 200. In this way, the conductive portions of the second PCB may be electrically connected to the corresponding conductive portions of the first PCB via the terminals 200, thereby establishing an electrical connection between the second PCB and the first PCB. The first PCB and the second PCB may communicate with each other by transmitting signals via the vertical connector 100 using a standardized protocol, such as a PCI protocol. Two sockets, i.e., a first socket 119 and a second socket 121, are shown in FIGS. 1 and 5A. The second socket 121 may receive a different portion of the same PCB being received by the first socket 119, or a different PCB. In some examples, the first socket 119 and the second socket 121 may be designed to provide access to a different number of terminals. For example, the first socket 119 may provide access to 68 (sixty eight) terminals and the second socket 121 may provide access to 56 (fifty six) terminals. In an aspect, this may allow the vertical connector to receive PCBs of different sizes. In another aspect, this may provide a dummy-proof design to prevent intentional or unintentional combinational or operational errors. It should be appreciated that the top face 103 of the housing 101 may have other numbers of sockets, such as one socket or more than two sockets. It should also be appreciated that the number of sockets may be the same as or different from that of retention mechanisms. For example, when the top face 103 of the housing 101 includes two sockets, the vertical connector 100 may include two retention mechanisms to allow the contact portions 203 of the plurality of terminals 200 to be accessible through the two sockets.

The vertical connector 100 may further include a positioning mechanism provided on the housing 101 for ensuring a proper positioning of the vertical connector 100 on the first PCB when the vertical connector 100 is mounted to the first PCB. For example, the positioning mechanism may be in the form of a positioning protrusion, with two positioning protrusions 123 shown in FIGS. 2 to 4 and 6. The two positioning protrusions 123 are provided on the bottom face 105 of the housing 101, near opposite ends of the vertical connector 100, respectively. However, it should be appreciated that the positioning protrusions 123 may be provided at other suitable locations on the bottom face 105. The positioning protrusions 123 may also be designed to provide a dummy-proof design to prevent the vertical connector 100 from being intentionally or unintentionally mounted to the first PCB in a wrong orientation. For example, when the vertical connector 100 is mounted to the first PCB, the positioning protrusions 123 may cooperate with corresponding positioning mechanisms (e.g., recesses or openings) in the first PCB to ensure a proper positioning of the vertical connector 100 on the first PCB. It should be appreciated that the vertical connector 100 may have other numbers and/or other forms of positioning mechanism.

The vertical connector 100 may further include a fixing mechanism for fixing the vertical connector 100 to the first PCB. For example, the fixing mechanism may be in the form of a fixing tab, with three fixing tabs 125 shown in FIGS. 2 to 4 and FIG. 6. The fixing tabs 125 may be formed of a metallic or non-metallic material. Receiving slots 127 may be formed in end portions of the housing 101 of the vertical connector 100 for receiving the fixing tabs 125. Each of the fixing tabs 125 may be received in the corresponding receiving slot 127 and protrude from the bottom face 105 of the connector 100, with the protruded portion of the fixing tab 125 received by a mating portion of the first PCB, whereby the vertical connector 100 may be securely fixed to the first PCB. In some examples, a portion of the fixing tab 125 protruding from the bottom face 105 of the connector 100 may be provided with a mounting hole. In some examples, each of the fixing tab may be T-shaped. It should be appreciated that the vertical connector 100 may have other numbers and/or other forms of fixing mechanisms.

In order to minimize a space occupied by the vertical connector 100 on the first PCB, a corner portion between at least two adjacent side faces of the side faces of the housing 101 may be formed as a chamfered surface 133 so as to reduce the space occupied by the housing 101 on the first PCB. In some examples, the corner portion between at least two adjacent side faces of the front side face 107, the rear side face 109, the left side face 111 and the right side face 113 of the housing 101 is formed as a chamfered surface 133. In some examples, all of the corner portions between adjacent side faces of the housing 101 are formed as chamfered surfaces 133. In some examples, the corner portions between adjacent side faces of the housing 101 proximate to an edge of the first PCB are each formed as a chamfered surface 133.

In conventional vertical connectors, the corner portions between adjacent side faces are typically formed as rounded or beveled portions. As compared with conventional vertical connectors, the corner portions between adjacent side faces of the vertical connector 100 being formed as chamfered surfaces may reduce a dimension of the vertical connector 100 and thus reduce the space occupied by the housing 101 on the first PCB. As such, the vertical connector 100 may be disposed closer to other components on the first PCB, thereby allowing for a more compact arrangement of components on the PCB. In addition, the vertical connector 100 may also be disposed closer to an edge of the first PCB, such that the space utilization on the first PCB may be optimized. These allow for reducing the dimension of the PCB, such that the entire assembly, including the vertical connector and PCB, may be manufactured at a lower cost, and may be more miniaturized and more lightweight.

FIG. 5B illustrate a comparison of the case where the corner portions between adjacent side faces of the vertical connector 100 are not formed as the chamfered surfaces 133 and the case where the corner portions are formed as the chamfered surfaces 133, wherein the dashed line B represents a general profile of the corner portions between adjacent side faces of the vertical connector 100 in the case where the corner portions are not formed as the chamfered surfaces 133. As compared to the case where the corner portions between adjacent side faces of the vertical connector 100 are not formed as the chamfered faces 133, the corner portions between adjacent side faces of the vertical connector 100 being formed as chamfered face 133 allows the corner portions to be indented inward by a distance S, wherein the distance S is a vertical distance from an intersection line of planes in which the adjacent side faces of the vertical connector 100 are located to the corresponding chamfered face 133. For some small size vertical connectors 100 (e.g., the 0.6 mm card edge connector as described above), the corner portions between adjacent side faces being formed as chamfered surfaces 133 allows the corner portions to be indented inward by at least 0.36 mm, as compared to the case where the corner portions are not formed as the chamfered surfaces 133.

FIGS. 5C and 5D schematically illustrate the arrangements of the vertical connector 100 relative to an edge 401 of the printed circuit board 400 in the cases where the corner portions of the vertical connector 100 are not formed as the chamfered surfaces 133 and are formed as the chamfered surfaces 133, respectively, wherein FIG. 5C schematically illustrates a general profile of the corner portions between adjacent side faces of the vertical connector 100 in the case where the corner portions of the vertical connector 100 are not formed as the chamfered surfaces 133. In some examples, the printed circuit board 400 may have curved edges. As can be seen from FIGS. 5C and 5D, the corner portions between adjacent side faces of the vertical connector 100 being formed as the chamfered surfaces 133 allows the corner portions to be indented inwardly such that the vertical connector 100 can be disposed closer to an edge 401 of the printed circuit board 400 when mounted on the printed circuit board 400, as compared to the case where the corner portions are not formed as the chamfered surfaces 133. This allows the space utilization on the printed circuit board 400 to be optimized, thereby allowing for reducing a dimension of the printed circuit board 400, which in turn allows the entire assembly, including the vertical connector 100 and the printed circuit board 400, to be manufactured at a lower cost, and to be more miniaturized and more lightweight.

In some embodiments, portions of opposite ends of the housing 101 that are proximate to the bottom face 105 may protrude outward to form a platform. As shown in FIGS. 1 to 6, portions of the left and right ends of the housing 101 that are proximate to the bottom face 105 protrude outwardly to form a first platform 129 and a second platform 131, respectively. The first platform 129 and the second platform 131 may be configured to provide additional mechanical support to the vertical connector 100 when the vertical connector 100 is mounted to the first PCB. In some examples, the receiving slots 127 for receiving the fixing tabs 125 may be formed in the first platform 129 and the second platform 131. In some examples, the receiving slots 127 for receiving the fixing tabs 125 may be formed through the first platform 129 and the second platform 131. In this case, the fixing tabs 125 may be fitted into the receiving slot 127 from a side of the first platform 129 and the second platform 131 opposite to the bottom face 105 and then protrude partially from the bottom face 105. It should be appreciated that the housing 101 may have only one platform.

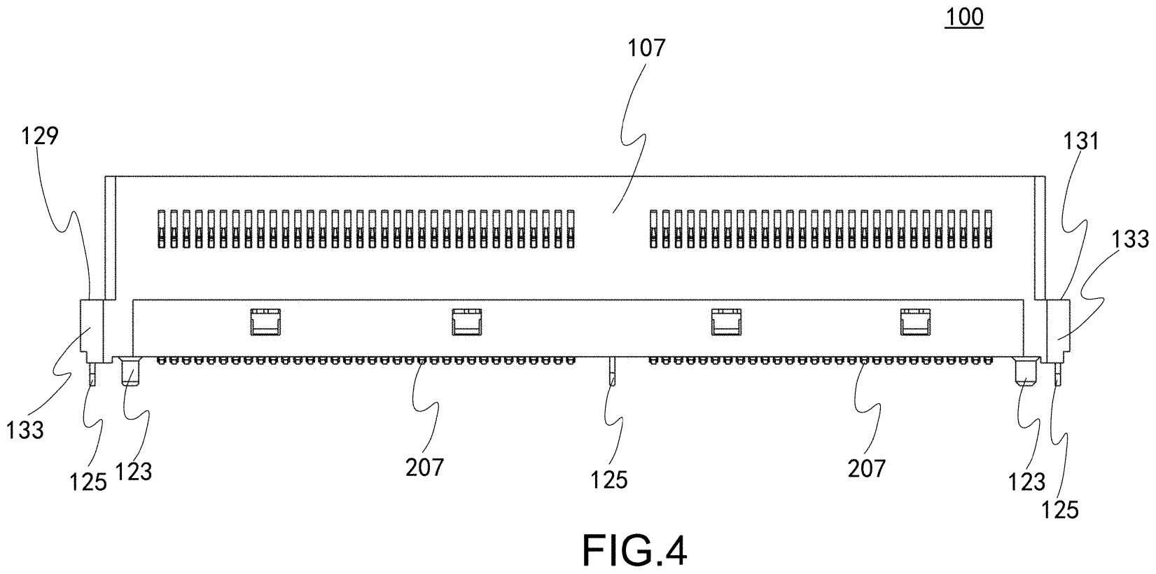

As shown in FIGS. 1 to 6, the chamfered surfaces 133 may be formed in corner portions of the first platform 129 and the second platform 131, respectively, to reduce the space occupied by the platform on the first PCB, thereby reducing the space occupied by the housing 101 on the first PCB. In some examples, as shown in FIGS. 4 to 6, the chamfered surfaces 133 may be formed in the two corner portions of each of the first platform 129 and the second platform 131, such that the first platform 129 and the second platform 131 each tapers outwardly, resulting in that each of the first platform 129 and the second platform 131 has a substantially trapezoidal shape. In this way, it is possible to allow the vertical connector 100 to occupy less space and to be disposed closer to other components on the first PCB, thereby allowing for a more compact arrangement for the components on the PCB. In addition, the vertical connector 100 may also be disposed closer to an edge of the first PCB such that the space utilization on the first PCB may be optimized. These allow for reducing a dimension of the PCB, such that the entire assembly, including the vertical connector and PCB, may be manufactured at a lower cost, and may be more miniaturized and more lightweight. It should be appreciated that the housing 101 of the vertical connector 100 may have one platform or more than two platforms.

Although the present disclosure is described in detail above in connection with a vertical connector, it should be appreciated that the present disclosure is also applicable to right angle connectors. Unlike the vertical connector 100, in a right angle connector, a socket is formed in a side face of the insulative housing, rather than a top face thereof, and terminals of the right angle connector are configured such that contact portions of the terminals are accessible via the socket. For example, the right angle connector may be used to connect a mezzanine card to a mother board. In some examples, the right angle connector may be configured to be mounted to a first PCB (such as a motherboard), such that the tail portions of the terminals of the right angle connector are electrically connected to the conductive portions (for example, conductive traces) of the first PCB. A second PCB (such as a mezzanine card) may be inserted into the socket such that the conductive portions of the second PCB are disposed in contact with the contact portions of the corresponding terminals. In this way, the conductive portions of the second PCB may be electrically connected to the corresponding conductive portions of the first PCB via the terminals of the right angle connector, thereby establishing an electrical connection between the second PCB and the first PCB. The first PCB and the second PCB may communicate with each other by transmitting signals using the right angle connector using a standardized protocol, such as a PCI protocol.

It should also be appreciated that the terms “first” and “second” are only used to distinguish an element or component from another element or component, and that these elements and/or components should not be limited by the terms.

The present disclosure has been described in detail in conjunction with specific embodiments. Obviously, the above description and the embodiments shown in the appended drawings should be understood to be exemplary and do not constitute a limitation on the present disclosure. For the person skilled in the art, various variations or modifications falling within the scope of the present disclosure can be made without departing from the spirit of the present disclosure.

What is claimed is:

1. An electrical connector, comprising:
an insulative housing comprising a top face comprising a socket, a bottom face opposite to the top face, and a plurality of side faces extending between the top face and the bottom face, the plurality of side faces comprising first and second side faces extending perpendicularly to each other; and
a plurality of terminals disposed in the insulative housing, each of the plurality of terminals comprising a contact portion and a tail portion, the contact portion being accessible through the socket of the insulative housing, and the tail portion protruding from the bottom face of the insulative housing;
wherein the insulative housing comprises a chamfered surface connecting one of the first side faces and one of the second side faces.

2. The electrical connector of claim 1, wherein the insulative housing comprises a platform projecting outwardly at one end of the insulative housing that is proximate to the bottom face.

3. The electrical connector of claim 2, wherein the platform comprises a corner portion comprising the chamfered surface.

4. The electrical connector of claim 3, wherein:
the chamfered surface is a first chamfered surface, and
the platform comprises a second chamfered surface such that the platform has a trapezoidal shape.

5. The electrical connector of claim 1, wherein the plurality of terminals are arranged in two terminal rows mutually opposed and spaced apart in the insulative housing, with the terminals in each terminal row aligned therein.

6. The electrical connector of claim 1, further comprising:
at least one retention mechanism for retaining the plurality of terminals in place relative to each other.

7. The electrical connector of claim 6, wherein the at least one retention mechanism is overmolded around the plurality of terminals.

8. The electrical connector of claim 6, wherein the insulative housing comprises the at least one retention mechanism.

9. The electrical connector of claim 6, wherein the at least one retention mechanism is formed separately from the insulative housing and removably mounted into the insulative housing.

10. The electrical connector of claim 9, wherein the retention mechanism comprises two halves having interlocking mechanisms, each half retaining a terminal row formed by some of the plurality of terminals.

11. The electrical connector of claim 1, further comprising:
a positioning mechanism for ensuring a proper positioning of the electrical connector on the electronic system when the electrical connector is mounted to an electronic system.

12. The electrical connector of claim 1, further comprising:
a fixing mechanism for fixing the electrical connector to an electronic system.

13. The electrical connector of claim 1, wherein the electrical connector is a vertical connector or a right angle connector.

14. The electrical connector of claim 12, wherein the electronic system is a printed circuit board.

15. The electrical connector of claim 1, wherein:
the one of the first side faces extends in a first plane,
the one of the second side faces extends in a second plane,
the first plane and the second plane cross each other along a line, and
the chamfered surface is spaced from the line by a distance no less than 0.36 mm.

16. The electrical connector of claim 2, wherein:
the platform comprises slots for receiving tabs.

17. An electronic system, comprising:
a printed circuit board; and
an electrical connector comprising:
an insulative housing comprising
a socket,
a bottom face mounted against the printed circuit board, and
a plurality of side faces extending perpendicular to the bottom face, the plurality of side faces comprising first and second side faces extending perpendicularly to each other; and
a plurality of terminals disposed in the insulative housing, each of the plurality of terminals comprising a contact portion and a tail portion, the contact portion being accessible through the socket of the insulative housing, and the tail portion protruding from the bottom face of the insulative housing;
wherein:
the printed circuit board comprises a first edge and a second edge and curved corner joining the first edge and the second edge;
the electrical connector is mounted to the printed circuit board with the first side face adjacent and parallel to the first edge and the second side face adjacent and parallel to the second edge; and
the insulative housing comprises an angled surface connecting the first side face and the second side face, the angled surface being mounted adjacent the curved corner.

18. The electronic system of claim 17, wherein:
the insulative housing comprises a socket portion including the socket and at least one platform extending from the socket portion in a direction parallel to the bottom face; and
the angled surface comprises a surface of a platform of the at least one platform.

19. The electronic system of claim 18, wherein:
the platform is a first platform;
the at least one platform comprises a second platform, extending from the socket portion in a direction opposite the first platform;
the angled surface is a first angled surface; and
the second platform comprises a second angled surface.

20. The electronic system of claim 19, further comprising:
a plurality of fixing tabs extending through the first platform and the second platform and engaging the electrical connector to the printed circuit board.
